(19) United States
(12) Patent Application Publication
(10) Pub. No.: US 2010/0037072 A1
(43) Pub. Date: Feb. 11, 2010

(54) Detachable Vehicle Computing Device

(75) Inventor: Allen Nejah, San Jose, CA (US)

Correspondence Address: PATENT LAW GROUP LLP, 2635 NORTH FIRST STREET, SUITE 223, SAN JOSE, CA, 95134, US

(73) Assignee: SunMan Engineering, Inc., San Jose, CA (US)

(21) Appl. No.: 12/537,223

(22) Filed: Aug. 6, 2009

Related U.S. Application Data
(60) Provisional application No. 61/086,551, filed on Aug. 6, 2008.

(51) Int. Cl. G06F 1/26; G01S 1/00

(52) U.S. Cl. 713/310; 342/357.09

(57) ABSTRACT

There is a need to have a computer system attached to a vehicle. This attached computer system controls many of the car's functions as well as provides multi-media and broadband connectivity for the passengers. A secondary detachable computer utilizing a display system needs to be able to share resources between the two computer systems. The present disclosure details how to partition such a system whereby the detachable computing device operates as a stand-alone computer and additionally is able to utilized functions from the computer attached to a vehicle.

### CROSS REFERENCE TO RELATED APPLICATIONS

This application claims the benefit of U.S. Provisional Application No. 61/086,551, filed Aug. 6, 2008, which is incorporated herein by reference. This application is related to U.S. patent application Ser. No. ______ entitled “Digital Antenna,” which is concurrently filed and incorporated herein by reference.

### FIELD OF INVENTION

This invention relates to the computer and automotive industries. Additional fields relate to the multimedia entertainment field. Additional fields include wireless technology.

### DESCRIPTION OF RELATED ART

As technology advances to new levels of integration, it is now possible to achieve a high level of integration. This opens up new possibilities and creates new market segments and products. Of particular interest is the motor vehicle. A general-purpose computer can be used within a motor vehicle for multiple purposes. New advances in automotive engineering now incorporate sensors that monitor tire pressure, oil pressure, fluid levels (gas, oil, brake fluid). Other functions control braking, powered steering, cruise control, windshield wipers, etc. Many cars are being equipped with video cameras to assist with parking and security. In order to control these devices, a central embedded computer system is being employed to supervise all of these operations.

New wiring standards have evolved that interconnect these various devices to the central computer. These include but are not limited to CAN, LAN, MOST, and FLEXRAY. Traditionally a low cost embedded microprocessor is used and a controller means. This computer is not visible to the driver or passengers, and typically sits under the hood. Some of the information is presented and delivered to the dashboard, indicators lights, and other means.

Other devices employing the use of computer technology include GPS technology and real-time map generation software. Some car manufactures include these devices as standard equipment.

After market devices utilizing computers include DVD players, and other multimedia devices are quickly becoming common place. Personal computers attached to the car are now starting to show up. For years, police cars have used on-board computing devices that permit data to be transmitted wirelessly to the police station. Police cars are now equipped with video recording devices that may be used as evidence. This police computing device has a graphical display system. These systems do no integrate or communicate with the vehicle itself. Typically, the only thing the vehicle provides is power, a holding stand, and a radio interface.

Some newer cars now come equipped with GPS devices that display maps and directions. These are often combined with XM radio and CD-ROM players. Some newer models even include an iPOD docking station that allows playing music to the vehicle's sound system. The iPOD can be considered a remote computing device. The GPS system can be considered an attached computing device. Such a system is limited to specific data transfer. The iPOD is not capable of controlling or interfacing to the broad spectrum of capabilities that a fully configured system might provide. Most of these features and products come about through incrementalism. A top-down systems level solution will provide a means of providing a platform where new possibilities never before imagined can take place.

New laws in many states now forbid the use of hand-held devices such as cell phones by a driver. Wireless headsets, and speaker phones can connect to the vehicle's sound system by means of an FM transmitter. Such systems are limited in scope and functionality.

Once a high-powered computer is connected to the vehicle, many new applications are possible. One possible idea is driver assistance. This can be as simple as providing intelligent cruise control systems that adjust the vehicle speed according to speed zones, auto-navigation in case the driver falls asleep, automated parallel parking. Voice activated status can provide both visual and audio status of current car status. Integrating these various discrete implementations into a central processing core would save cost and provide improved functionality.

Cruise control systems have been around for decades. These systems are useless in congested traffic. Some of the more advanced systems include a user controlled mechanical means of speeding up the vehicle thereby setting the cruise control to maintain a higher speed. Other systems include a means of coasting allowing friction and wind resistance to slow down the vehicle; this is later followed by resetting the cruise control mechanism. It is often more convenient to simply turn the cruise control off. A more intelligent system could be devised to provide improved automation of vehicular speed control. Such a system could account for stop and go traffic by maintaining a safe distance between vehicles.

### BRIEF DESCRIPTION OF THE DRAWINGS

In the drawings:

FIG. 1 illustrates a system with two separate computing devices, one attached to a vehicle and the other mobile, in one or more embodiments of the present disclosure; and

FIG. 2 illustrates a functional system diagram of the system of FIG. 1 in one or more embodiments of the present disclosure.

Use of the same reference numbers in different figures indicates similar or identical elements.

### DETAILED DESCRIPTION

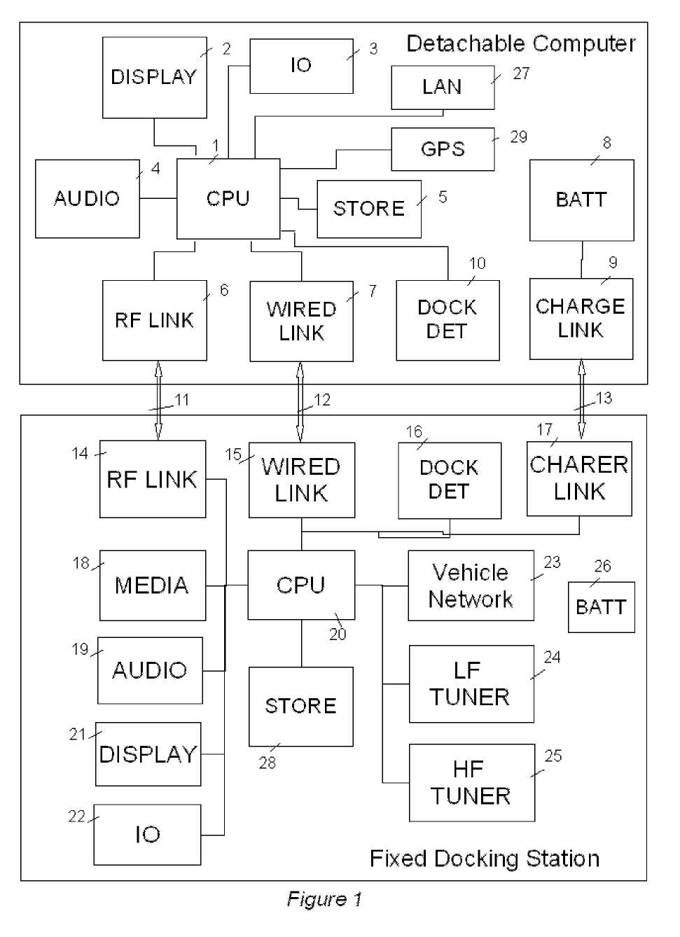

In one or more embodiments of the present disclosure, a system comprises a computer centric docking station affixed to a motor vehicle. Referring to FIG. 1, the docking station is essentially an embedded computer system. This system utilizes blocks 14 through 26 of FIG. 1. There is no requirement that the CPU(1-20) support any particular operating system. The CPU(1-20) is powered by the vehicle's battery system(1-26). The battery system includes DC-DC converter devices consistent with the power needs of the CPU(1-20) and its connected peripherals.

The charger link(1-17) derives its power from the battery(1-26). The charger link(1-17) transfers power from to the docked Detachable computer through the charging link(1-9). There are various means of transferring power that can be utilized. The simplest method comprises a physical contacting connector. In order to reduce insertion force, one or more embodiments of the present disclosure utilize a magnet with sufficient holding force to guarantee contact. Other possible methods include an AC inductive transformer means. This may not be preferred because of possible interference with AM radio.

Typical with most vehicles, are large external antennas that connect external AM/FM radio broadcasts. This class of antennas are improved over portable hidden antennas. Transferring AM/FM radio comprises transferring data from the LF Tuner (1-24) to the CPU(1-20) and then through the RF LINK(1-14). Note that it is not necessary to used the wired link(1-15) as the main objective here is to send the data to the speakers (AUDIO 1-19). When the detachable computer is remote from the docking computer, the remote RF LINK(1-6) receives the data wirelessly(1-11) from the fixed RF LINK(1-14). This data travels through the remote CPU(1-1) which then sends the data to the remote AUDIO system(1-4).

The HF radio of the fixed docking system(1-25) provides high-speed Internet or Cell Phone connectivity. There are various standards emerging utilizing spread spectrum technology. Various standards include CDMA, 3G, 4G, GSM, LTE, WiMax, etc. This resource can be shared with the remote CPU(1-1) over the wired link(1-12) or the wireless link(1-11).

The docked CPU may optionally support user interface buttons(1-22) and a miniature display system(1-21) for controlling the MEDIA player(1-18). The MEDIA player(1-18) can be a CD Player, DVD Player, HD-DVD Player, BlueRay Player, or even a tap recorder. As the main display system(1-2) requires visual data from the MEDIA player(1-18), the wired link(1-15) transfers its data over the wired link interface wires(1-12) and delivers the data to the wired link receiver(1-7) which said data is converted to pixels via the CPU(1-1) and sent to the remote display(1-2). Typically, MEDIA data traversing either the wired link or the wireless link is compressed. The remote CPU(1-1) is responsible for decompressing the data so that it can be displayed on the display unit(1-2). When the remote computer is detached, the Wired link(1-12) is disabled. If the RF-LINK has sufficient bandwidth, data is sent as is over the RF link(1-11). If this is not the case, data bandwidth can be reduced through the docked processor(1-20). Those skilled in the art of video compression technology know how to convert a high-definition encoded bit stream into a low-bandwidth encoded bit stream. The quality of the recoded stream is a function of the available bandwidth of the RF LINK(1-11).

One or more embodiments of the present disclosure utilize a vehicle Network interface(1-23). The data from this network can support various standard protocols such as CAN and LAN. The data is generally low-bandwidth and can easily be transmitted over either the RF-LINK(1-11) or the WIRED LIND(1-12). The vehicle network incorporates various sensors such as tire pressure and fluid levels. High-end serial protocols such as MOST are generally used to transmit audio to the speakers(1-19). It is possible for the remote computer system to control various functions of the vehicle through the vehicle network(1-23). One possible use is to start the engine and pre-cool the cabin before you get there. Another use may be to use the remote computer as a entry key system. The possibilities are only limited by one's imagination.

Each computer system has a docking detection means(1,16, 1-10). It is possible to remove one of these detectors and wirelessly transmit the status over the RF-LINK(1-11). The docking detection system can be combined with the charger link(1-13) or the wired link(1-12). There are various possible means of implementation. The simplest comprises a simple mechanical switch means. Other possible systems include photodiode interrupters, magnetic reed switches, and capacitor proximity sensors. The docking-detection system is very important for power management.

In one or more embodiments of the present disclosure, the wired link (1-12) comprises a magnetically assisted contact switch. Using hot-swappable high-speed serial technology means minimizes the number of contacts required by the wired link(1-12). The data throughput must support the combined resources of all concurrent data between the two systems. One or more embodiments of the present disclosure utilize a separate input and output differential signal means. Possible candidates for this serial link comprise PCT express or IEEE1394. Software in both CPU blocks(1-1, 1-20) must account for unexpected dock and undock events. A software protocol means is used to re-transmit data through the RF-LINK(1-11) in order to recover missing data. While MEDIA(1-18) data is being delivered through the wired link(1-12), a lower bandwidth version of the data is also delivered over the RF-LINK(1-11). In the event of a undock event, the lower bandwidth version of the data can substitute the higher bandwidth data. By synchronizing the frame rates and buffering the data, the user's perception will appear as a seamless transition. Because the display unit (1-2) is small, the video degradation may not even be noticeable.

The detachable computer requires some peripherals in order to be useful as a stand-alone device. These peripherals if desired may be transferred over the RF LINK(1-11) or the WIRED LINK(1-7). Possible IO devices(1-3) include one or more USB connectors, touch screen interface, keyboard, and mouse. The storage device (1-5) is shared between the remote computer and the docked computer. When the docked computer requires storage, the data is transmitted over either the wired link(1-12) or the wireless link(1-11). It is possible to place storage devices on both CPU blocks; this however adds significant cost. One or more embodiments of the present disclosure use a single storage device(1-5). One or more embodiments of the present disclosure generally consider the fixed docking station CPU(1-20) a slave to the remote CPU(1-1). Processing load can be shared if desired. Some functions of each CPU may be independent of each other as needed. Only data pertinent to the opposing processor need be transmitted over the link interfaces(1-11, 1-12).

When the main removable computer is detached, it is often convenient to connect a large display screen, keyboard and mouse. In one or more embodiments of the present disclosure, the display (1-2) includes a CRT controller and VGA connector thereby enabling connection to a large display device. This could additionally be an LVDS digital connection to a LCD display. As this detached computing device could operate as a work computer or laptop system, a connection to a local area network(1-27) would be most convenient. A software driver could be written that would bridge the stationary computer attached to the vehicle to the remote display computer thereby making available broadband services to the remote computer.

The fixed device could additionally utilize a storage device (1-28) such as a hard disk system. As communications are bi-directional, each computing device can use both storage devices interchangeably. For improved performance, the local storage device offers the best performance. The remote storage device could provide backup services for its software and configuration settings. This makes the combined system more robust.

Another important mobile device constitutes interfacing to a GPS global positioning satellite (1-29). This also includes local based services (LBS), Traffic Information and map generating software. This allows a user to find restaurants, gas stations, and hotels. Also provided are maps, directions, etc. When the remote computer is docked inside the vehicle, much of the signal from the satellite is blocked due to the metal construction of the vehicle. The GPS signal can probably be accessed from the high-frequency, high-bandwidth antenna (1-25). Most likely, the GPS signal will require its own antenna. Note that GPS data once processed is low bandwidth. This signal can then be used to replace the weak signal of the local GPS antenna when the removable computing device is docked within a vehicle. When the units are separated, the two separate GPS signals can help the car owner find his car!

On the other hand, it would also useful to take this powerful computer with you when you are not in the vehicle. Some functionality must remain however. If we were to partition functions that must remain with the car with function that can travel with the main display device, and provide a means of communications between the two devices, we would end up with capabilities beyond the functionality of a fixed computer display unit. One possible feature would be to remotely monitor the state of the car through a wireless connection. This includes security such as remotely recording video from a camera attached to the vehicle. If a passenger remains with the car, it is possible to establish 2-way communications. Some of the communications requires too much bandwidth such as transmitting the contents of a BlueRay DVD movie real time. As technologies continue to evolve, even these limitations may not prove insurmountable. The removable computing device should be self-sufficient. An interface to a large display system as well as audio speakers and local area network. The remote display computing device could also include GPS technology (global positioning satellite) independent of the stationary docking computer attached to the vehicle.

The removed display/computer combination would act like a notepad computer with touch screen interface. This could be used as a personal data assistant. Also, removing the main display device would discourage theft. A means of reducing the number of interconnect between the removable computer/display device and its docking station while maintaining a subjectively invisible connection between the two systems is highly desirable. The main computer display system could communicate with the docking station via wireless connection. Using inductive coupling, the battery of the display/computer system could be recharge while docked. Other possible solutions are magnetic connectors that can easily be detached. For the various high-speed/high-bandwidth interconnect, this may be a good choice. The docking station requires some kind of processor, howbeit of lower performance/cost. It is desirable that some functionality remains with the docking device.

The present disclosure describes the interconnection between a computer system and a permanently attached docking station whereby the detachment and reattachment of the main computer system with display screen seamlessly does not interrupt the operation of the computer. There are some problems that must be handled when the vehicle is turned off. If for example, a movie is being played and at the same time the vehicle's power is shut down, there are two conflicting needs that need to be addressed. One need is to continue watching the movie, the other need is to conserve power to the vehicle. Generally, conservation of power is more important than watching the movie, so a possible solution is to perform a user controlled shut down procedure. During the first stage, the movie is paused with a request from the user to either power down the unit, or to continue playing the movie. The main computer display unit needs to know if the unit is docked or removed from its docking station. If the unit is docked, the logical thing to do is to immediately go into power-standby mode.

Note that there may be insufficient bandwidth to wirelessly connect a high-definition movie to the docking station. When the units are attached, a high-speed serial link can connect the two units. When detached, the high-definition movie can be downgraded to standard definition or lower to reduce the bit rate. It is desirable that this operation be performed seamlessly in such a way that the audio and video streams do not exhibit any pause or delay. One possible solution is to buffer both the high-speed stream (connected via the docking connector), and the low-speed stream (connected wirelessly). Events such as turning off the vehicle's power will require user intervention. Simply removing the display while the vehicle's power is enabled does not require intervention. The sound system should continue to play through the vehicle's sound system until either the display unit is removed from the car, or a headphone device is plugged in, or some user controlled action is performed.

It is desirable that the device continues its operation without interruption. Occasionally, interference will disrupt reception. A storage-buffering device is used to prevent this. Data is buffered in advance of the content that is being displayed.

Modern high-bandwidth communications is performed at frequencies in the gigahertz realm. As frequencies increase, the size of the antenna decreases. This means that the antenna between the docking station and the display computer unit can be reduced is sized to the point of being hidden. The vehicle requires a long antenna for receiving AM/FM radio and other long band signals. In one or more embodiments of the present disclosure, the vehicle also connects to broadband services using an external short antenna.

It is highly desirable that both of these services be made available to the remote display computer unit. If the remote display computer device is to remain detached from the docking station for an extended amount of time, it is important that power management of the vehicle battery starting system is not drained too much. Remote power monitoring is a desirable feature.

Computers with huge operating systems require a substantial amount of time to boot. General consumer electronic devices generally are function within seconds of turning on the power. Computers can take several minutes to boot. In order to get around these issues, it is important that the computer have various stages of power standby modes that prevent having to reboot the computer display unit. Because there are basically two computers involved, (one in the docking station, the other in the display) both units must interactively control the standby power mode in a way intuitive to the end user. The detached unit must account for the power status of the remote docking station, as well as its local power.

It is important that much of the bulk associated with a computer system be minimized as much as possible. Attaching a DVD/HD drive on the display is not desirable as this adds both bulk and weight. Another problem is the fact that DVD/HD drives require a substantial amount of power to drive the internal laser diode, power to drive the motors, and power to drive the electronics. Car batteries have substantial power storage capabilities; a DVD drive represents an insignificant load to the vehicle's battery. The main difficulty comprises the difficulty of sending an enormous amount of data between the display unit computer and the docking station computer.

A vehicle battery voltage monitoring means is must be used to prevent excessive battery drain; not being able to start the motor would be disastrous. One possible solution would be to provide a separate battery for the docking station. When the vehicle is operating, the generator can charge the docking station's battery as well as the main vehicle's battery. This does add some cost however.

Careful segregation between various functional components is vital to a successful docking vehicle-computing device.

Traditional segregated devices are greatly enhanced when combined under computer control. Traditional GPS systems provide 2-dimensional information for mapping systems. The actual data coming from the GSP transponder (2-41) includes 4 dimensions: longitude, latitude, altitude, and time. The time can be used to update the computer's real-time clock. Altitude information along with barometric pressure sensors (2-25) can be used to control the carburetor and improve fuel economy by adjusting the fuel air mixture. The GPS (2-41) along with Broadband Services (2-43) can enhance the traditional location based services with real-time tourist information and more detailed restaurant information. The resolution of the GPS system can be improved by including triangulation data from the Broadband system (2-43).

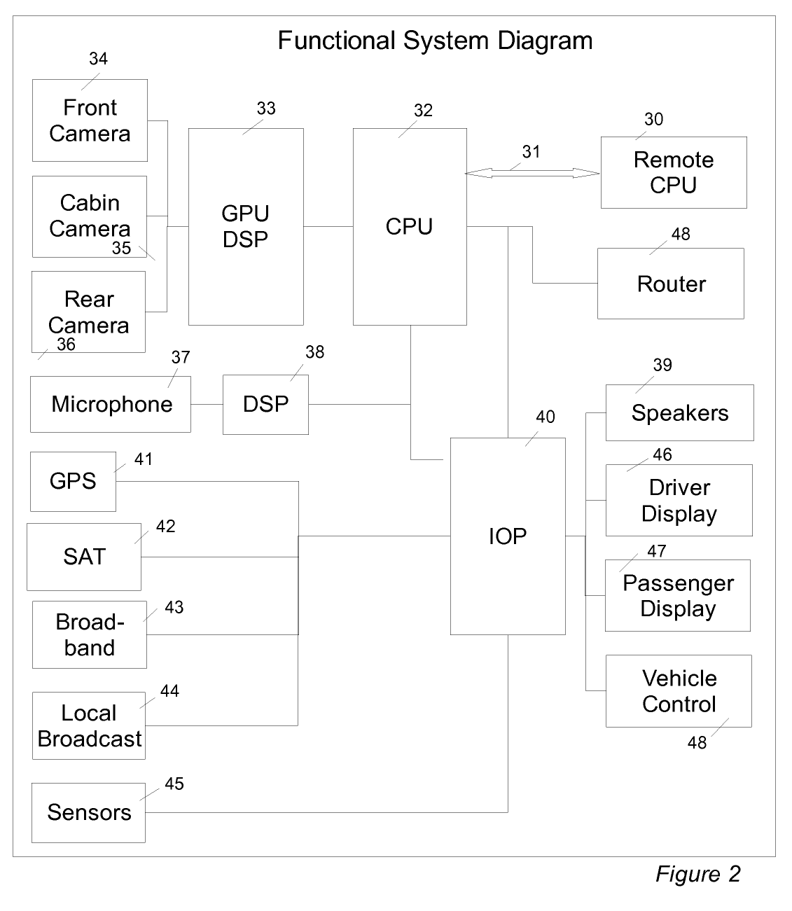

With today's technologies, and the integrated features displayed in FIG. 2, it is now feasible to provide auto-navigation assistance. The front camera(2-34) image can be processed using edge-detection algorithms using a high-speed digital signal graphical processing system(2-33). The edge detection can find the lines in the road. This data can be further refined by including GPS position (2-41) information. Even state of the art cruise control systems have difficulties maintaining speed in downhill grades. Adding additional braking control or transmission control can improve the accuracy. Adding accelerometer sensors (2-45) along with GPS altitude data, and road information from the Broadband services can provide sufficient information to anticipate the upcoming variables associated with cruise control systems. Add to this speed zone information from the Internet (2-43), and roadside sign recognition (2-34 and 2-33), the cruise control can be automatically adjusted and updated. In congested traffic, vehicular speed can be controlled to provide a safe distance in front of the car. Unlike humans with slow reaction time, a computer could provide improved braking assistance by measuring acceleration and distance of cars in front of or behind the vehicle. The internal cabin camera (2-35) with processing help from the graphical processing unit or GPU(2-33) can provide gesture recognition of the driver. In this case, the auto-navigation could kick in thereby saving lives. The rear camera (2-36) could record reckless/drunken driver behavior, and forward this information to the police. The sound system speakers (2-39) could also be used to wake up a drowsy driver. Parking assistance could also be automated. Many drivers have difficulty performing parallel parking procedures. Utilizing proximity sensors (2-45), and video cameras(2-34 and 2-45) allowing the CPU(2-32) to take over the vehicle control (2-48) will enable perfect parallel parking.

The microphone(2-37) combined with a digital signal processing device(2-38) can provide voice recognition services. The Semantics of human speech could be processed by the CPU (2-32) and virtually allow the driver to direct the computer where to go like the typical back-seat driver. This same microphone system could also provide a hands-free phone interface. The cabin camera (2-35) along with gesture recognition software in the GPU (2-33) could augment the speech recognition algorithm similarly the way humans process speech. The Input Output Processor IOP (2-40) can be used to augment echo cancellation performed by the DSP(2-38).

Inside the cabin of the vehicle, a wireless router(2-48) is used to provide a hot spot for passengers with laptop computers. Software for the router is contained within the CPU(2-32). Data from the Broadband service(2-43) is routed through the IOP(2-40). The IOP(2-40) can be constructed from a FPGA or ASIC device utilizing cross-point switching technology. The IOP(2-40) additionally routes multimedia data (1-18) to passengers. The experience is nothing less than a home entertainment system on wheels. In one or more embodiments of the present disclosure, the Driver Display(2-46) is implemented in the docked remote CPU(2-30).

Local broadcasts such as AM/FM/TV can be enhanced by providing voice control via the microphone(2-37). A sleepy driver can be awoken by changing the radio station from talk radio to RAP music. A voice command, “put it back” can return the tuning back to the original station. Having access to the audio data delivered to the speakers (2-39) the speech recognition can be improved by removing the feedback that would otherwise occur. This allows separation of the speech signal from the superimposed music feedback from the speakers(2-39) into the microphone(2-37). Multiple voices from the cabin could confuse a speech recognition system. Augmentation is achieved by lip-reading via the cabin camera(2-35) and the GPU(2-33).

The docked computing device should be functional without the remote computing device. In one or more embodiments of the present disclosure, a simple LED or LCD display (1-21) provides a visual feedback to user interface 10 (1-22) comprising push buttons, joysticks, knobs and possibly an IR controller wand. This permits localized control over the MEDIA device (1-18). As an example, a passenger remaining behind change the radio station while the driver runs into the store with the remote computer. The IO block (1-22) or RF LINK(1-14) could additionally include a local wireless hot spot transceiver that could function without the docked remote computer. This would permit passengers remaining behind with laptop computers the ability to stay connected to the Internet.

With a large installed base of docking stations installed in multiple vehicles, it might be convenient to permit a foreign remote computer to dock with the docking device. For security, only the wired interface is utilized. In order to protect unwanted access to the car, a public key exchange system and encryption means are used to safeguard illegal access to a foreign docking station by wireless means. Biometric techniques (finger print scanner, voice recognition, retinal scan, etc.) can be used to authorize access to a foreign docked computing device. A lower cost method constitutes password protection. The benefit of connecting a foreign computer comprises the ability to exchange data, user profiles, and programs. This foreign remote computing device could be granted permanent access rights. Wireless access rights could also be granted. A common example could be a husband and wife exchanging the remote computing devices of their respective vehicles. Another possibility is the ability to sell one remote device and sell two docking devices: one docking device to be installed in a boat, the other docking device to be installed in a car. In such an environment, it may be convenient to communicate with the boat's docked computing device while approaching the dock.

The Vehicle Network (1-23) could provide a wireless interface to various standard vehicle networking standards. As some of these standards evolved, there are some incompatible interface means such as different type connectors. A variety of small and cheap wireless dongle could be placed on a CAN network instead of a wired connection. This small dongle could transmit using WiFi or Bluetooth. Instead of a wired connection, the Vehicle Network(1-23) utilizes a wireless means to communicate with a wireless dongle attached to the CAN or LAN network. This greatly simplifies installation, as there may not exist a convenient CAN or LAN connector near the DIN stack. Additionally, multiple standards could be interfaced to making the wireless connection virtually interface agnostic.

The docked computing device's Display (1-21) could include a windshield projector means to display gauge and speed information. This is known as a heads up display system. This may be preferred over traditional gauge displays that require the driver to look down periodically.

Speed control systems controlling both braking and acceleration can provide improved speed control over acceleration alone. Feedback control systems generally have difficulty controlling more than one device. Computer assistance can decide if braking or acceleration is needed. On a downhill grade, braking is generally the control mechanism. New braking systems capture the energy of braking by storing the energy rather than converting the energy to heat through friction. This would provide improved gas mileage. Other control means comprise changing the transmission gear ratio and using engine compression to slow down the vehicle. Laser measurement systems can be used to measure the distance between the front of the vehicle and the back of the vehicle ahead. This works by sending a short pulse and observing the reflection. Distance is measured by measuring the time it takes light to travel in air. As this is a round trip, the result is divided by two. Successive measurements can be used to measure speed by means of differentiation. Doppler radar techniques mix the frequency of the transmitting signal with the reflected signal. This creates a sum and difference signal that can be used to measure relative speed. If the signal were burst transmitted, the speed of light technique similar to the laser method could be used to measure distance. Another method utilizes a video camera. An edge finding algorithm is used to measure the size of the car. This in turn can be used to calculate the distance. Stereo cameras would make this more accurate. Lane width can also be used as a comparative means. Generally drivers tend to change lanes when there is a space to merge. Software must differentiate between a simple lane change from someone slamming on the brakes. In the case of a lane change, gradual slowing may be preferred. As the car making the lane change moves, the relative speed of the two cars ahead can determine if the car making the lane change will need to brake suddenly. In this case, more aggressive braking is required. The rear camera can detect someone tailgating and decide the optimal braking rate in order to prevent a rear-end collision. With a large installed base of compatible units, neighboring cars can communicate their respective locations further enhancing the decision matrix and safety. Combining two or more techniques such as laser and video ensures additional accuracy.

Steering control or auto-navigation can be activated when the internal camera sees that the driver is asleep. Gesture software can determine if the eyes are closed and the head in a non-upright position. Even temporary lapses like turning around a talking to a passenger can be very hazardous. At a certain point, the external cameras can detect the car drifting into another lane or off the road. In this case the steering column can be released from the distracted driver and controlled by the attached computer system. Lane departure software is accomplished using an edge detector. The lines in the road as well as the location of the car ahead can provide clues that can help the edge detector determine the location of the lane. The computer can make appropriate adjustments that keep the car in the lane. This can be also combined with the above speed control system in order to maintain both speed and direction. Combining these two technologies with GPS and Internet access, an operator can input the destination, and the computer can auto-navigate the entire trip. Infrared cameras can detect hazards such as deer or people obstructing the traffic far beyond the capabilities of humans particularly at night. Control can be returned back to the user when the gesture recognition system sees that the driver is in control once again.

The combination of GPS and broadband connectivity introduces additional features. One possible application represents targeted advertisements during travel. One advertisement may suggest that you take the next exit for a 30% discount of hammers. Another possibility is the exchange of data positions. As an example, you and a friend want to know which short cut is best. Position data is interchanged over the broadband network with respectively localized data from the GPS. Adding hands-free voice chatting further enhances the experience.

Video camera devices deliver an enormous amount of data and often swamp a CPU. In one or more embodiments of the present disclosure, the combination of a video digital signal processor and an FPGA device offers extensive flexibility. The FPGA device is really good at parallel processing algorithms. Additionally, new hardware algorithms can be programmed into the FPGA making it a future proof device. The cost of FPGA devices have been driven down sharply over the years. Dedicated video signal processors employ a SIMD (single instruction simultaneous data) processing engine are also very effective in processing large data sets. New algorithms are continually being developed including gesture recognition, and shape recognition. It is now possible to reliably interpret road signs, deer, cars, and trucks. Also possible are distance calculations and speed estimations of approaching vehicles. At night, it is difficult to judge if it is safe to pass a slow truck on a two lane road.

FIG. 1 describes two separate computing devices: one attached to a vehicle (lower block), the other mobile (upper block). The remote computing device contains a central processing unit or CPU (1-1). There are a large variety of CPU integrated circuits or chips that may be used in this configuration. In one or more embodiments of the present disclosure, an Intel Embedded Processor is used. The CPU includes memory devices, caching systems, BIOS ROM, and other such circuits familiar to those skilled in the art of computer systems design. The CPU (1-1) interfaces with a myriad of diversion input and output devices. User interface centric 10 devices designated as 10(1-3) include mouse and keyboard devices, and well as USB (Universal Serial Bus), IEEE1394 (FireWire), and various serial and parallel printer interfaces. Most modern computing devices also include networking devices as depicted in (1-27) which describes an Ethernet local area network device. Not common to most computing devices but useful in a portable device is a GPS (Global Positioning System) device depicted in the GPS block (1-29). This device tunes into orbiting satellites and extracts longitude and latitude. Other possible alternatives to GPS comprise cellular networks which can triangulate coordinate positions. A computer system needs a display device as depicted in (1-2). In one or more embodiments of the present disclosure, an LCD (liquid crystal display) with touch screen interface is used as a fixed display device. As it is desirable to keep the display small for portable use, it is sometimes convenient to plug in a larger display device. In one or more embodiments of the present disclosure, a VGA (Video Graphics Array) connector is also included within the display block (1-2). Most modern computers include multimedia capabilities. Along with a display, audio is needed (1-4). This block(1-4) consists of a DAC (digital-to-analog converter) system. Most small form-factor devices utilize a headphone amplifier. Other systems implement small speakers. In one or more embodiments of the present disclosure, a headphone amplifier system is used. As will all computing systems, a means of storing and running programs is vital. To this end, a storage device is utilized as depicted in the STORE (1-5) block. In one or more embodiments of the present disclosure, a hard disk storage device is used. Also possible are non-volatile memory devices such as flash memory. Generally non-volatile memory remains more expensive that traditional magnetic recording devices. Future devices may utilize an optical storage means. Portable computing devices must run on batteries as depicted in 1-8. In one or more embodiments of the present disclosure, a rechargeable battery device is used. The battery (1-8) is charged by the charge link block (1-9). The charge link block can be charged while the remote computer is docked with the fixed computing device. Also, charging can be accomplished through a power connector by means of an AC adapter. Interface 1-13 describes various means of transferring power from the fixed computing device and the portable computing device. The RF LINK(1-6) is used for bi-directional communications between the remote computing device and the fixed computing device when the two units are disconnected. The wired link (1-7) is used for bi-directional communications between the remote computing device and the fixed computing device when the remote computing device is docked or connected to the fixed computing device. Interface links (1-11) and (1-12) describe the means of how the two computing devices exchange data.

The fixed computing device additionally utilizes a CPU device (1-20) that interfaces to a variety of peripheral devices. The CPU block (1-20) also includes dynamic memory, cache memory, and ROM BIOS memory. In one or more embodiments of the present disclosure, this fixed computing device is connected to a vehicle. Vehicles generally have speakers for listening to radio broadcasts as depicted in the audio block (1-19). Another useful device includes recorded source material denoted MEDIA (1-18). In one or more embodiments of the present disclosure, this is a DVD player. With the remote-computing device removed from the system, some remaining functionality is needed. Block 1-20 describes basic 10 control comprising push buttons that inform the CPU (1-20) to control source material contained within the media block (1-18). In one or more embodiments of the present disclosure, a simple LED display device (1-21) is used to indicate track number, time, channel, and other state information. As with all computing devices, a non-volatile storage device (1-28) is needed to store programs. Power to the fixed computing device is taken from the vehicle's power system labeled BATT(1-26). This could also include a dedicated reserved rechargeable battery. Modem vehicles now include vehicle centric networking systems (1-23). Some popular and upcoming systems include: LAN, CAN, MOST, FLEXRAY, and APIX. In one or more embodiments of the present disclosure, the CPU (1-20) controls the low frequency tuner (1-24). In one or more embodiments of the present disclosure, the LF tuner (1-24) supports AM/FM radio and HD radio. Future version could additionally include SD and HD television broadcasts. In older traditional configurations, the radio and audio system have no connection to a computer system. The fixed computing device communicates with the remote computing device through the RF LINK(1-14) over the RF channel (1-11) when the two devices are disconnected. With the two computing devices connected, the WIRED LINK(1-15) communicates with the remote computing device over the wired interface link (1-12). Both computing devices utilize a docking detection as shown by 1-10 and 1-16. The fixed computing device charges the remote computing device by the charger link (1-17) over the charging channel (1-13).

FIG. 2 depicts a functional usage of the combined system comprising a remote computing device (2-30) and the fixed computer comprising the remaining blocks in FIG. 2. An advance configuration includes 3 separate camera devices: one internal (2-35) and two external (2-34 and 2-36). These three camera devices are further processed by a digital signal graphical processing unit (2-33). This graphical processing unit can perform tasks such as gesture recognition, proximity detection, and lane management. The data from the GPU/DSP block (2-33) can have this data further processed by the CPU (2-32). The CPU(2-32) can further transmit this and other data to a remote CPU (2-30) over a wireless medium (2-31). Inside the cabin of the vehicle, a microphone (2-37) connected to a digital signal processing device or DSP (2-38) can perform a myriad of functions such as a hands-free cell-phone interface device. The DSP (2-38) also receives data from the Input Output Processing Unit or IOP (2-40). This can help improve echo cancellation algorithms by including data to be sent to the speakers (2-39). Combining data from the GPS (2-41) satellites and Broadband services (2-43) can provide directions, navigation information and other location based services. Broadband services (2-43) also include VOIP technology thereby creating a more cost effective telephony function. Control over local broadcast (2-44) can be further enhanced by other system components. Vehicle control (2-48) includes functions such as cruise control, braking, steering, signaling, wiper, and lighting systems. Sensors (2-45) include functions such as proximity detection (for parking assistance), magnetic compass, infrared (night vision and fog), radar (collision prevention, ticket prevention), engine diagnostics, and fuel gauge. Placing these sensors under computer control (2-32) empowers additional functionality such as telemetric functions. The remote CPU(2-30) can access security information over the wireless interface(2-31). A wireless router (2-48) connected to the main CPU(2-32) can provide passenger access to the Internet via the shared Broadband connection(2-43). Multimedia can be delivered to passengers via the Passenger display(2-47). The driver display (2-46) could include a projection system showing vehicle status from various sensors (2-45). The remote CPU(2-30) once docked, could also assist the driver in a similar manner.

Various other adaptations and combinations of features of the embodiments disclosed are within the scope of the present disclosure. Numerous embodiments are encompassed by the following claims.

1. A battery operated remote computing device which said remote computing device integrates a display device means attachable to a stationary computing device affixed to a vehicle utilizing a docking interface means whereby the said stationary computing device exchanges data with the said remote computing device through a wireless interface means whereby the said remote computing device's battery is charged when the said remote computing device is connected to the said docking interface means.

2. The system of claim 1 that includes a wired interface means utilizing a high bandwidth wired transmission means that becomes available when the said remote computing device is connected to the said docking interface means whereby both the said wireless interface means and the wired interface means are active when the said remote computing device is connected to the said docking interface means.

3. The system of claim 2 whereby media data is transmitted in a high bandwidth data format over the said wired interface means and the same said media data is transmitted in a low bandwidth data format over the said wireless interface means and a detachment detection means whereby the said removable computing device utilizes the said low bandwidth data format when the two computing devices are disconnected and the said removable computing device utilizes the said high bandwidth data format when the said remote computing device is connected to the said docking interface means.

4. A vehicle networking interface means connected to the said stationary computing device of claim 1 whereby the said vehicle networking interface exchanges data with sensors attached to said vehicle, or with detectors attached to said vehicle, or with actuators attached to said vehicle, or with gages attached to said vehicle, or with controller devices attached to said vehicle, or with speakers attached to said vehicle, or with microphone devices attached to said vehicle, or with display devices attached to said vehicle, or with camera devices attached to said vehicle, or with radio devices attached to said vehicle, or with radar devices attached to said vehicle, or with laser devices attached to said vehicle.

5. The vehicle networking interface means of claim 4 utilizing one or more interface standards such as: LIN, CAN, MOST, FLEXRAY, and APIX.

6. The vehicle networking interface means of claim 4 implemented by means of a wireless transceiver connected to the said stationary computing device and a wireless transceiver connected to a remote vehicle network.

7. The system of claim 4 whereby the said remote computing exchanges data with the said stationary computing device thereby enabling remote control access of the said vehicle networking interface means by the remote computing device.

8. The stationary computing device of claim 1 that interfaces with one or more externally attached antennas to said vehicle whereby said externally attached antennas are used for external communications.

9. The system of claim 8 whereby one of the said antennas is optimally tuned for the reception of AM band signals.

10. The system of claim 8 whereby one of the said antennas is optimally tuned for the reception of FM band signals.

11. The system of claim 8 whereby one of the said antennas is optimally tuned for the reception of VHF television signals.

12. The system of claim 8 whereby one of the said antennas is optimally tuned for the reception of UHF television signals.

13. The system of claim 8 whereby one of the said antennas is optimally tuned for the reception and transmission of CB signals.

14. The system of claim 8 whereby one of the said antennas comprises an antenna optimally tuned for the reception of GPS, and a decoding means, and a transmission means to the said stationary computing device whereby low bandwidth geo coordinate data and time data are transferred to said stationary computing device.

15. The system of claim 8 whereby one of the said antennas comprises an antenna optimally tuned for the reception and transmission of high frequency carrier signals, and a decoding means, and an encoding means and a communications means to the said stationary computing device whereby data is exchanged with said stationary computing device.

16. The stationary computing device of claim 1 that interfaces with one or more internally attached antennas to said vehicle whereby said internally attached antennas are used for internal communications and said internally attached antennas include radio transmitters and radio receivers that interface with the said stationary computing device.

17. The system of claim 16 whereby one or more of the antennas is optimally tuned to receive or transmit WiFi signals.

18. The system of claim 16 whereby one ore more of the antennas is optimally tuned to receive or transmit Bluetooth signals.

19. The system of claim 16 whereby the stationary computing device implements a wireless router device.

20. The system of claim 16 whereby the stationary computing device implements a wireless web server.

21 to 69. (canceled)
